(19) United States
(12) Patent Application Publication
(10) Pub. No.: US 2007/0047435 A1
(43) Pub. Date: Mar. 1, 2007

(54) Advertising availability for ad-hoc networking based on stored device history

(75) Inventor: Robert A. Marples, Coral Springs, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/216,306

(22) Filed: Aug. 31, 2005

(51) Int. Cl. H04L 1/00

(52) U.S. Cl. 370/216

(57) ABSTRACT

A communication device (110) that includes a wireless adapter (112) and a processor (114). The wireless adapter can communicate via a Bluetooth communications protocol. The processor can determine whether at least a second communication device (130) is identified in a device history list (120). In response to determining that the second communication device is identified in the device history list, the processor can automatically attempt to connect to the second communication device via the wireless adapter. In response to determining that the second communication device is not identified in the device history list, the processor can automatically initiate discoverable mode in the communication device. The processor also can generate a user notification in response to a detection of the second communication device. In addition, the processor can add the second communication device to the device history list in response to connecting to the second communication device.

### BACKGROUND OF THE INVENTION

1. Field of the Invention

The present invention generally relates to wireless communications and, more particularly, to establishing wireless communication links.

2. Background of the Invention

The use of Bluetooth to support wireless communications has proliferated in recent years. Bluetooth is a telecommunications industry specification that describes how electronic devices can be interconnected using a short range wireless connection. For instance, using Bluetooth technology, a user can use a wireless headset to communicate via a cell phone or personal digital assistant (PDA).

To connect a wireless device to another electronic device using Bluetooth, the wireless device is typically placed into a “discoverable” mode so that the other electronic device can detect and synchronize with the wireless device. Placing the wireless device into discoverable mode usually requires some form of user interaction, such as the pressing of a button. Unfortunately, many users fail to read instructions that accompany a new wireless device and become frustrated when they are not able to immediately use the device to communicate wirelessly.

### SUMMARY OF THE INVENTION

The present invention relates to a communication device that includes a wireless adapter and a processor. The wireless adapter can communicate via a Bluetooth communications protocol. The processor can determine whether at least a second communication device is identified in a device history list. In response to determining that the second communication device is identified in the device history list, the processor can automatically attempt to connect to the second communication device via the wireless adapter.

In response to determining that the second communication device is not identified in the device history list, the processor can automatically initiate discoverable mode in the communication device. The processor also can generate a user notification in response to a detection of the second communication device. In addition, the processor can add a reference identifying the second communication device to the device history list in response to connecting to the second communication device.

The processor also can initiate discoverable mode in the communication device in response to a connection failure occurring during the attempt to connect to the second communication device.

The communication device also can include a connection timer. A timeout of the connection timer can identify the connection failure. If a connection failure occurs when attempting to connect to the second communication device, the processor automatically attempt to connect to a third communication device via the wireless adapter.

The invention also relates to a method for establishing a wireless communication link from a first communication device. The method can include determining whether at least a second communication device is identified in a device history list. In response to determining that the second communication device is identified in the device history list, the method can include automatically attempting to connect to the second communication device, for example in accordance with a Bluetooth protocol.

In response to determining that the second communication device is not identified in the device history list, the method can include automatically initiating discoverable mode in the first communication device. A user notification can be generated in response to a detection of the second communication device and a reference identifying the second communication device can be added to the device history list.

The method also can include automatically initiating discoverable mode in the first communication device in response to a connection failure occurring during the attempt to connect to the second communication device. For example, a connection timer can be initiated, and a timeout of the connection timer can identify the connection failure. The method also can include automatically attempting to connect to a third communication device in response to a connection failure occurring during the attempt to connect to the second communication device.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a block diagram of a system that is useful for understanding the present invention.

FIG. 2 is a flowchart that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method that facilitates the interconnection of wireless devices, for instance those devices which connect to each other using the Bluetooth communication protocol. In particular, upon activation, a first communication device can automatically refer to a history list which contains a history of previous device connections. If the history list contains a reference to a second communication device to which the first communication device was previously connected, the first communication device can automatically attempt to establish a wireless connection with that device. If the history list does not contain any device references, or if the attempted connection fails, the first communication device can automatically enter a discoverable mode in which the first communication device makes itself discoverable to a second communication device and/or attempts to discover a second communication device.

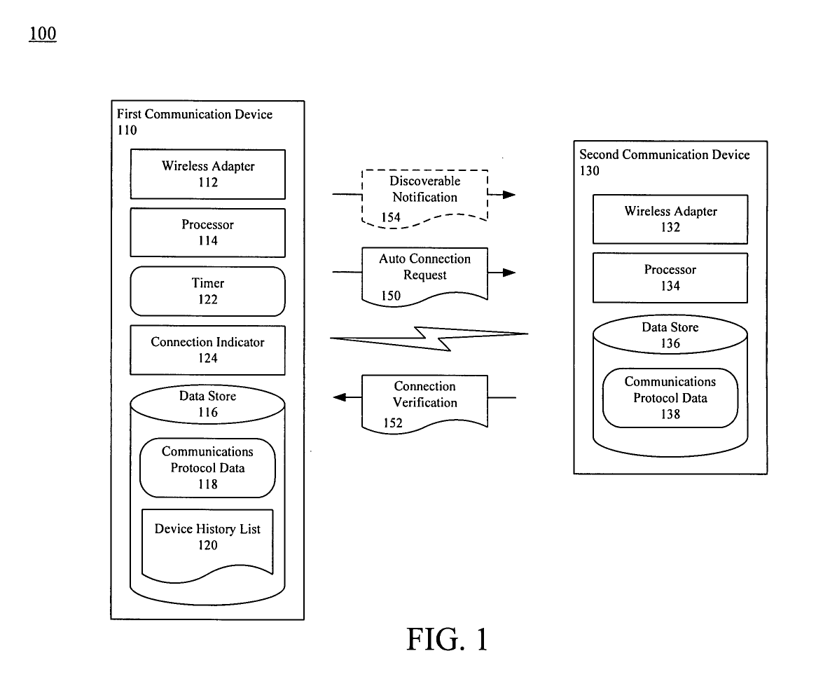

FIG. 1 depicts a block diagram of a system 100 that is useful for understanding the present invention. The system can include a first communication device 110 and a second communication device 130. The first communication device 110 can include a wireless adapter 112, a processor 114 and a data store 116. Similarly, the second communication device can include a wireless adapter 132, a processor 134 and a data store 136.

Each of the wireless adapters 112, 132 can include any integrated circuit (IC) or combination of circuit components that implement a communications protocol for wireless communication. For example, the wireless adapters 112, 132 can support communications in accordance with the Bluetooth protocol, the IEEE 802.11 wireless communications protocol, or any other communications protocol implemented by the devices 110, 130.

Each of the processors 114, 134 can include a central processing unit (CPU), a digital signal processor (DSP), an application specific integrated circuit (ASIC), a programmable logic device (LPG), and/or any other suitable processing device. The processors 114, 134 can be communicatively connected to any of the components of the respective devices 110, 130 to receive, process and generate data in accordance with the methods described herein.

The data stores 116, 136 each can include one or more data storage devices. A data storage device can be, for example, a magnetic storage medium, such as a hard disk drive (HDD), an optical storage medium, such as a digital video disk (DVD), a magneto/optical storage medium, an electronic storage medium, such as random access memory (RAM), read-only memory (ROM) or flash memory, or any other suitable storage device. Moreover, each data store 116, 136 can include any combination of storage devices.

Each of the data stores 116, 136 can contain communications protocol data 118, 138. The communications protocol data 118, 138 can be processed by the respective processors 114, 134 to implement wireless communications between the respective devices 110, 130. For instance, the communications protocol data 118, 138 can be processed to implement Bluetooth communications, 802.11 wireless communications, or any other communications implemented by the devices 110, 130.

The data store 116 associated with the first communication device 110 also can contain a device history list 120. The device history list 120 can contain a list that identifies devices with which the first communication device 110 has previously successfully connected. The device history list 120 can be queried by the processor 114 to implement the methods described herein. For instance, when the first communication device 110 is powered on, the processor 114 can query the device history list 120 to determine whether any devices are identified in the device history list 120. If so, the processor can cause the wireless adapter 112 to automatically transmit a connection request 150 to one or more of such devices. For example, if the second communication device 130 is identified in the device history list 120, the first communication device 1 10 can automatically attempt to transmit a connection request 150 to the second communication device 130. If the second communication device 130 receives the connection request 150 and is available to connect to the first communication device 110, the second communication device 152 can transmit a connection verification 152 to the first communication device 110 to confirm that a connection has been established.

If, however, the first communication device 110 does not receive the connection verification 152, the first communication device can query through the device history list 120 and transmit an auto connection request 150 for each additional device which may be identified in the device history list 120 until a connection verification 152 is received.

If no connection verifications 152 are received, the first communication device 110 then can automatically transmit a discoverable notification 154 indicating that the first communication device 110 is in discoverable mode. In discoverable mode, the first communication device 110 is available to be discovered for connection.

The discoverable mode is not necessarily a permanent mode, however. For example, a timer 122 can be provided and the device 110 can enter a non-discoverable mode after a timeout of the timer. This feature can be used to preserve power in the first communication device 110. The timer 122 also can be used to provide timing for the various other processes described herein. For example, the timer 122 can be used by the first communication device 110 as a connection timer to time connection processes, or performing any other timing tasks that are required.

The first communication device 110 also can include a connection indicator 124 to indicate when a connection is established between the first communication device 110 and another device. The connection indicator can be, for example, an indicator lamp or an audio transducer. For instance, when the first communication device 110 connects to another device, such as the second communication device 130, the processor 114 can cause the indicator lamp to flash or become illuminated, or the processor 114 can cause the audio transducer to emit an audible sound. Still, a user notification can be generated in any other suitable manner and the invention is not limited in this regard.

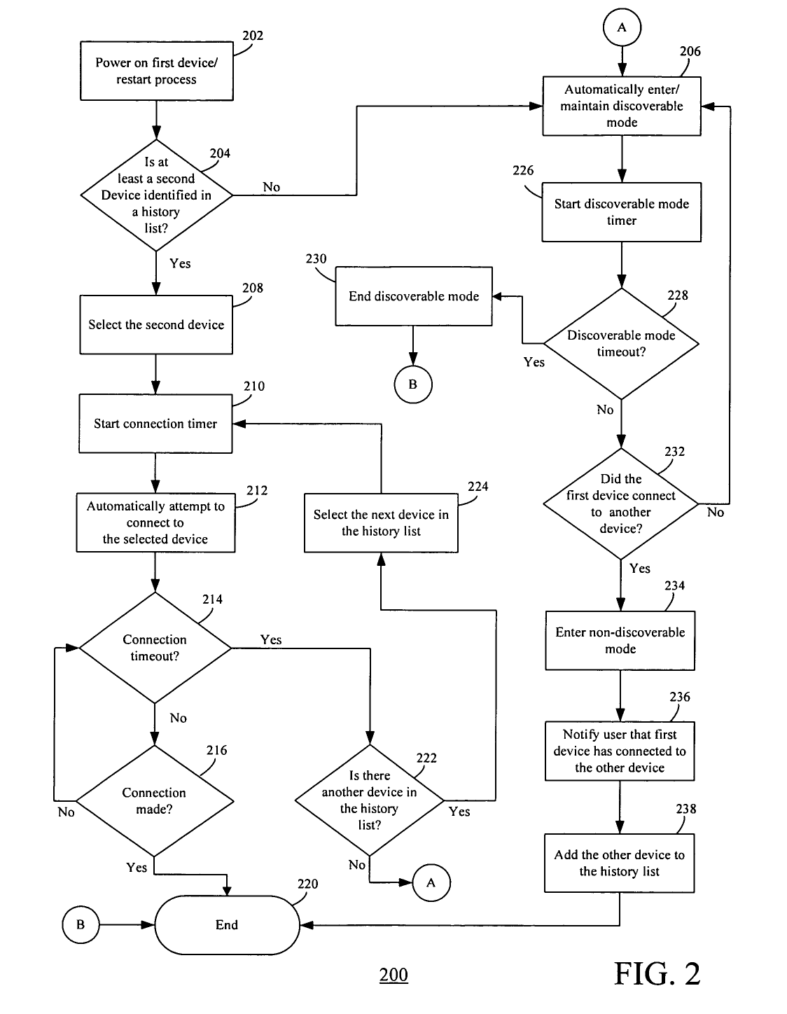

FIG. 2 is a flowchart that describes a method 200 that is useful for understanding the present invention. Beginning at step 202, the first communication device can be powered on. At decision box 204, the history list can be queried to determine whether at least a second communication device is identified in the history list. If not, the first communication device can automatically enter discoverable mode, as shown in step 206. In the discoverable mode, the first communication device can broadcast its address to be discovered by a second device. Upon discovering the address, the second device can use the address to calculate a communication frequency that can be used to attempt to connect to a service provided by the first communication device. For example, a connection can be made to a capability exchange service in the first communication device, which can provide a way for the second device to access a desired service provided by the first communication device. The second device then can establish a connection to the desired service.

If, however, at least a second communication device is identified in the device history list, at step 208 the second communication device can be selected. At step 210 a connection timer can be started and, proceeding to step 212, the first communication device can automatically attempt to connect to the second communication device. Referring to decision box 214 and decision box 216, if a connection is made before a timeout of the connection timer, the process can end, as shown in step 220. On the other hand, a timeout of the connection timer before a connection is made can indicate a connection failure, and the process can continue to decision box 222 where it is determined whether another device is identified in the device history list.

If another device is not identified in the device history list, the process can proceed to step 206 where the device automatically enters discoverable mode. If another device is identified in the device history list, the process can proceed to step 224 where a next device in the history list is selected. The process then can continue to step 210, where the connection timer is again started, and the connection attempt can be repeated.

From step 206 where the first communication device has entered discoverable mode, the process can proceed to step 226 where a discoverable mode timer is started. Referring to decision boxes 228 and 232, and step 230, the first communication device can maintain discoverable mode until a timeout of the discoverable mode timer, at which point the process can end as shown in step 220. In one arrangement, the process can be restarted and begin again at step 202. For example, the process can be restarted at periodic intervals. In another arrangement, the process will only be restarted in response to the first communication device again being powered on or in response to a user input.

At decision box 232 it can be determined whether the first communication device has connected to a second device. If the first communication device has not been connected to the second device, the first communication device can maintain in the discoverable mode, as shown in step 206. For example, if the first communication device determines that it has been discovered by the second device, but the second device only requests further information about the first communication, the first communication device can wait to enter a non-discoverable mode until after a connection has been established. Meanwhile, the first communication device can remain discoverable.

When a connection is made, for instance to utilize a service provided by the first communication device, the process then can proceed to step 234 and the device can enter a non-discoverable mode. Proceeding to step 236, a user notification can be generated to notify the user that the first communication device has connected to the second device. At step 238, a reference identifying the second device can be added to the history list of the first communication device, and the process again can end at step 220.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A communication device, comprising:
a wireless adapter; and
a processor that determines whether at least a second communication device is identified in a device history list;
wherein the processor automatically initiates discoverable mode in the communication device in response to determining that the second communication device is not identified in the device history list, and the processor automatically attempts to connect to the second communication device via the wireless adapter in response to determining that the second communication device is identified in the device history list.

2. The communication device of claim 1, wherein the processor automatically initiates discoverable mode in the communication device in response to a connection failure occurring during the attempt to connect to the second communication device.

3. The communication device of claim 2, further comprising a connection timer, wherein the connection failure is identified by a timeout of the connection timer.

4. The communication device of claim 1, wherein the processor automatically attempts to connect to a third communication device via the wireless adapter in response to a connection failure occurring during the attempt to connect to the second communication device.

5. The communication device of claim 1, wherein the processor generates a user notification in response to a detection of the second communication device.

6. The communication device of claim 5, wherein the processor adds a reference identifying the second communication device to the device history list in response to connecting to the second communication device.

7. The communication device of claim 1, wherein the wireless adapter communicates via a Bluetooth communications protocol.

8. A machine readable storage, having stored thereon a computer program having a plurality of code sections executable by a machine for causing the machine to perform the steps of:
determining whether at least a second communication device is identified in a device history list;
responsive to determining that the second communication device is identified in the device history list, automatically attempting to connect to the second communication device; and
responsive to determining that the second communication device is not identified in the device history list, automatically initiating discoverable mode in a first communication device.

9. The machine readable storage of claim 8, further causing the machine to automatically initiate discoverable mode in the first communication device in response to a connection failure occurring during the attempt to connect to the second communication device.

10. The machine readable storage of claim 9, further causing the machine to initiate a connection timer, wherein the connection failure is identified by a timeout of the connection timer.

11. The machine readable storage of claim 8, further causing the machine to automatically attempt to connect to a third communication device in response to a connection failure occurring during the attempt to connect to the second communication device.

12. The machine readable storage of claim 8, wherein the automatically initiating discoverable mode in the first communication device further comprises generating a user notification in response to a detection of the second communication device.

13. The machine readable storage of claim 12, further causing the machine to add a reference identifying the second communication device to the device history list in response to connecting to the second communication device.

14. The machine readable storage of claim 8, wherein automatically attempting to connect to the second communication device comprises communicating in accordance with a Bluetooth protocol.

15. A method for establishing a wireless communication link from a first communication device, comprising:
determining whether at least a second communication device is identified in a device history list;
responsive to determining that the second communication device is identified in the device history list, automatically attempting to connect to the second communication device; and
responsive to determining that the second communication device is not identified in the device history list, automatically initiating discoverable mode in the first communication device.

16. The method according to claim 15, further comprising automatically initiating discoverable mode in the first communication device in response to a connection failure occurring during the attempt to connect to the second communication device.

17. The method according to claim 16, further comprising initiating a connection timer, wherein the connection failure is identified by a timeout of the connection timer.

18. The method according to claim 15, further comprising automatically attempting to connect to a third communication device in response to a connection failure occurring during the attempt to connect to the second communication device.

19. The method according to claim 15, wherein the automatically initiating discoverable mode in the first communication device further comprises generating a user notification in response to a detection of the second communication device.

20. The method according to claim 19, further comprising adding a reference identifying the second communication device to the device history list in response to connecting to the second communication device.
